(19) United States
(12) Patent Application Publication
(10) Pub. No.: US 2002/0066837 A1
(43) Pub. Date: Jun. 6, 2002

(54) Portable music performance stand

(76) Inventor: Monte C. Dunbar, Wheat Ridge, CO (US)

Correspondence Address: John L. Isaac, Esq., Isaac & Associates, Suite 900, 143 Union Blvd.,, Lakewood,, CO, 80228-1829, US

(21) Appl. No.: 09/730,069

(22) Filed: Dec. 5, 2000

(51) Int. Cl. A47F 5/00; F16M 11/00; A47B 19/00

(52) U.S. Cl. 248/122.1; 248/125.7; 248/441.1

(57) ABSTRACT

A portable music stand is disclosed for securely holding a plurality of music performance equipment components. The stand includes a base for supporting the stand on a surface. An elongated shaft is releasably engaged with and extends vertically upwardly from the base, and a plurality of adjustable attachment members are disposed for selective mounting along the shaft. Each attachment member is adapted to support at least one music performance equipment component. Finally, a plurality of adjustment elements are provided, with each interconnecting one attachment member with the shaft. The adjustment elements are adapted to permit one-handed vertical repositioning of the associated attachment member along the length of the shaft.

### BACKGROUND OF THE INVENTION

1. Field of the Invention

The present invention relates generally to music stands and, more particularly, to portable music stands utilized in stage performances. Specifically, the present invention relates to music stands which are adapted to also carry at least one additional piece of equipment required by a performer during a performance while eliminating stage floor congestion.

2. Description of the Prior Art

Bands, church praise teams, combination vocal/instrument ensembles, and many other types of entertainment groups and organizations all require a wide variety of pieces of musical and electronic equipment in order to perform properly on stage. Such equipment can include vocal and instrument microphones, microphone booms, sheet music racks and holders, monitor speakers and the like. Previously, these various pieces and components of musical performance equipment generally stood alone, each on its own stand or on the floor in the case of some monitors. Thus, a single performer who is both a vocalist as well as an instrumentalist, such as playing a guitar, required a vocal microphone stand, a music rack stand, a guitar microphone stand and a floor monitor speaker. When this combination of equipment is then multiplied by a plurality of vocal/instrumental performers, the performing stage or floor becomes quite crowded with dozens of individual stands and equipment. This situation is compounded by the various electrical cables leading from monitor speakers and instruments to wall outlets for power. If performers attempt to share microphone or music rack stands in order to reduce the sheer number of pieces of equipment on the stage, this unfortunately places all the remaining pieces of equipment for the two performers in very close proximity to each other. This still results in an unacceptable situation.

Various types of stands for providing positioning and support of multiple pieces of equipment have been devised in the past. U.S. Pat. Nos. 5,799,919 and 5,6300,566 illustrate attempts at these types of stands for computers and the like. However, none of these illustrated devices are applicable to the situation discussed above. U.S. Pat. No. 5,622,344 illustrates a collapsible tripod stand which meets the portability need for performing groups. However, it too is unsatisfactory in meeting the above stated needs for reducing the clutter on a performing stage. U.S. Pat. Nos. 4,383,487, 5,611,508 and D256,754 all illustrate music stands which attempt to combine functions of at least two musical equipment components, in particular a music sheet rack and a microphone stand. However, these devices also fall far short of the requirements for a portable music stand capable of supporting a plurality of different types of musical equipment components required by a single vocal and instrumental performer.

U.S. Pat. No. 5,165,631 is directed to a music stand adapted for supporting various pieces of music paraphernalia which are from time to time associated with music playing. However, this particular device is intended for music practice and for the storage of sheet music and various pieces of musical equipment that might be needed during music practice. It does not address the aforementioned problem of various pieces of music performance equipment and paraphernalia required for use simultaneously by a performer on a stage. Thus, there remains a need for a music stand which is adapted to support a plurality of different types of pieces of musical equipment and components simultaneously in support of a vocal and instrumental performer. Moreover, such performers frequently need to make positional adjustments of the various pieces of equipment during performance. When such pieces of equipment are supported on a single stand, it is paramount that the various pieces of equipment be capable of being moved vertically along the stand quickly and easily by the performer while the performer is actually singing and or playing his or her instrument. Thus, one-handed adjustment of the position of such musical equipment components on the stand becomes very desirable if not in fact necessary.

### SUMMARY OF THE INVENTION

Accordingly, it is one object of the present invention to provide an improved music stand.

It is another object of the present invention to provide a music stand which is capable of supporting a plurality of different music performance equipment components simultaneously.

Yet another object of the present invention is to provide a music/microphone stand which reduces the needed stage floor space while still providing easy access to a plurality of music equipment components by a performer.

Still another object of the present invention is to provide a music stand which will simultaneously support a voice microphone, a guitar or other music instrument microphone, a sheet music rack holder, and a monitor speaker for the performer.

A further object of the present invention is to provide such a music stand wherein the positioning of the various equipment components on the stand may be easily adjusted with one hand during actual performance and use of the stand.

Still another object of the present invention is to provide an attachment member for supporting equipment components on a music stand and which is adapted to permit one-handed vertical repositioning of the associated attachment member and supported equipment along the length of the stand.

To achieve the foregoing and other objects and in accordance with the purpose of the present invention, as embodied and broadly described herein, a portable music stand is disclosed for securely holding a plurality of music performance equipment components. The stand includes a base for supporting the stand on a surface. An elongated shaft is releasably engaged with and extends vertically upwardly from the base, and a plurality of adjustable attachment members are disposed for selective mounting along the shaft. Each attachment member is adapted to support at least one music performance equipment component. Finally, a plurality of adjustment elements are provided, with each interconnecting one attachment member with the shaft. The adjustment elements are adapted to permit one-handed vertical repositioning of the associated attachment member along the length of the shaft.

The music stand of the invention is designed to support music performance equipment components that may be selected from the group consisting of microphones, microphone clamps, microphone booms, monitor speakers and sheet music rack holders. In one preferred form, the music stand includes at least two of the adjustable attachment members, one for supporting a monitor speaker and one for supporting a sheet music rack holder. In yet another preferred form, the music stand includes a third adjustable attachment member for supporting a microphone clamp and microphone secured thereto. The music stand of the invention may also further include a microphone boom attachment clamp disposed at the uppermost distal end of the shaft.

The adjustable attachment member of the invention may be configured to include an outer sleeve sized to readily slide over the elongated shaft, and a bracket arm extending radially outwardly from the sleeve adapted to mount and carry at least one music performance equipment component. In one form of the invention, the bracket arm is detachably secured to the sleeve, while in another form the bracket arm is an integral portion of the sleeve. The bracket arm may be configured to include at least two portions aligned no more than about 1500 relative to each other. Preferably, the bracket arm portions include a first portion aligned approximately perpendicular to the sleeve, and a second portion aligned at approximately 900 relative to the first bracket arm portion.

The adjustment element of the music stand may be configured to include an inner tubular element disposed radially inwardly of the outer sleeve for positioning between the outer sleeve and the shaft, the inner tubular element having an elongated slot defined in its length to permit adjustment of the diameter thereof. Preferably, the tubular element is in the form of a flexible split bushing.

The present invention also concerns itself with an attachment element for adjustably securing music performance equipment to a substantially vertically aligned, tubular shaft member for support thereon, the attachment element being adapted to permit one-handed position adjustment thereof along the length of the shaft. Preferably, the attachment element includes an outer tubular sleeve sized to readily slide over the tubular shaft member. A bracket arm extends radially outwardly from the sleeve and is adapted to mount and carry at least one component of music performance equipment. Finally, an inner tubular element is disposed radially inwardly of the outer sleeve for positioning between the outer sleeve and the shaft member. The inner tubular element has an elongated slot defined in its length to permit adjustment of the diameter thereof. Preferably, the inner tubular element is adapted to leverage against the shaft member to maintain the vertical position of the attachment element relative to the shaft member resulting from weight imposed thereon by the bracket arm and any music performance equipment supported thereby.

### BRIEF DESCRIPTION OF THE DRAWINGS

The accompanying drawings which are incorporated in and form a part of the specification illustrate preferred embodiments of the present invention and, together with a description, serve to explain the principles of the invention. In the drawings:

FIG. 1 is a side perspective view of one music stand embodiment constructed in accordance with the present invention;

FIG. 2 is a side perspective view of another music stand embodiment constructed in accordance with the present invention;

FIG. 3 is an enlarged, exploded side schematic of an adjustable attachment member constructed in accordance with the present invention;

FIG. 4 is a top plan view of the adjustment element taken substantially along line 4-4 of FIG. 3;

FIG. 5 is an exploded side schematic of an adjustable attachment member constructed in accordance with the present invention and arranged for positioning along a vertical music stand shaft;

FIG. 6 is a top plan view of the adjustable attachment member taken substantially along line 6-6 of FIG. 5;

FIG. 7 is a side elevation of the adjustable attachment member of FIG. 5 positioned on a vertical music stand shaft;

FIG. 8 is an enlarged, exploded side schematic of an adjustable attachment member constructed in accordance with the present invention and arranged for supporting a music performance equipment component; and

FIG. 9 is a top plan view of the bracket end of an adjustable attachment member taken substantially along line 9-9 of FIG. 8.

### DETAILED DESCRIPTION OF THE PREFERRED EMBODIMENTS

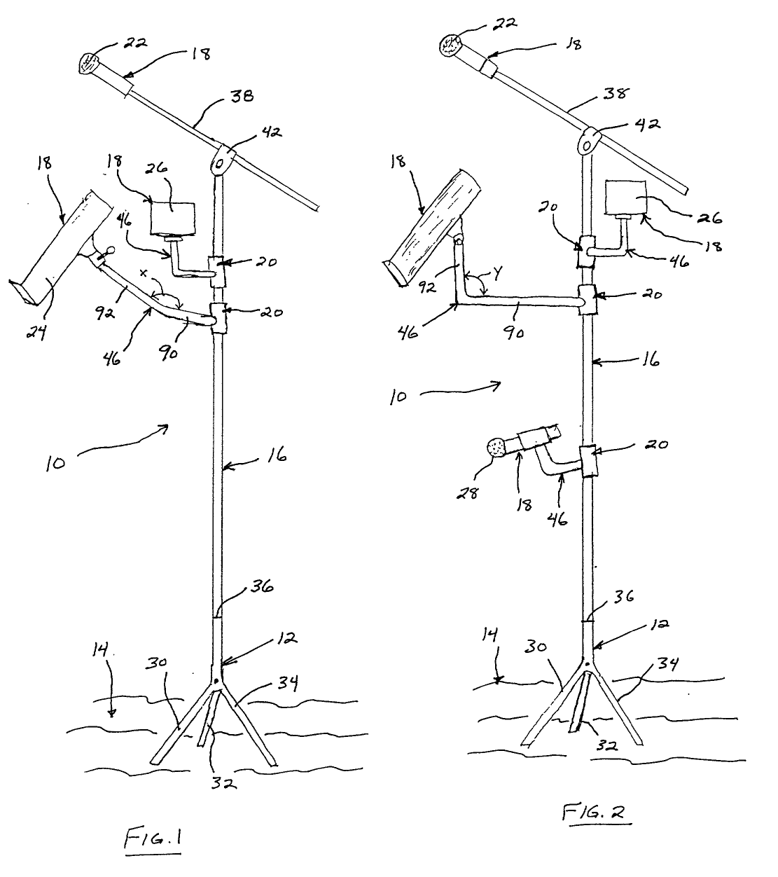

Referring now to FIGS. 1 and 2, a music stand 10 is illustrated and constructed in accordance with the present invention. It should be understood, however, that while specific embodiments are illustrated and discussed in detail herein, the present invention is not be specifically limited to these examples and embodiments but is to be interpreted and limited only by the claims appended hereto.

The music stand 10 includes a base portion 12 which is designed to support the stand 10 on a surface 14 such as a stage floor or the like. An elongated shaft 16 extends vertically upwardly from and is supported by the base 12. A plurality of music performance components 18 are secured to and supported by the shaft 16 utilizing a plurality of adjustable attachment members 20. While the shaft 16 may support any type of music performance component 18, examples as illustrated include a vocal microphone 22, a sheet music rack 24, a monitor speaker 26, and a guitar or other instrument microphone 28. The adjustable attachment members 20 are constructed to enable the performance components 18 to be positioned in any desired location along the shaft 16, such as illustrated by the two different positions of the monitor 26 in FIGS. 1 and 2. Moreover, the vertical position of any adjustment member 20 along the shaft 16, along with its associated music performance component 18, may be readily adjusted utilizing only one hand as described in greater detail below.

The base 12 may be of any known and desired construction. The illustrated embodiment is a tripod arrangement wherein the legs 30, 32 and 34 may be readily folded. Moreover, the base 12 may be detached from the shaft 16 at the juncture 36. As described below, the remaining components secured to the shaft 16 by the adjustable attachment members 20 may also be easily removed from the shaft 16, thereby making the entire music stand device 10 easily disassembled and transported. The music stand 10 may also include a microphone boom 38 secured to the distal end 40 of the shaft 16 by a boom mounting element 42, which is known in the art.

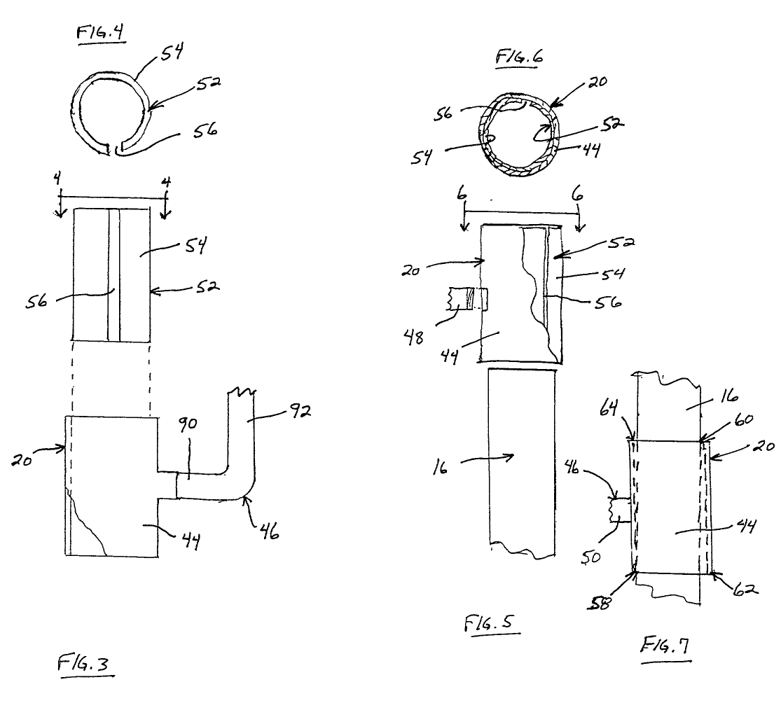

Referring now to FIGS. 3-7, the adjustable attachment member 20 in preferred form includes an outer tubular sleeve 44 which is sized to readily fit over the elongated shaft 16. A mounting bracket 46 extends radially outwardly from the sleeve 44 and is shaped to hold and support a music performance equipment component 18 as described in greater detail below. The bracket 46 can be in the form of a detachable bracket 48 or it may be an integrally formed bracket 50 as a part of the sleeve 44. While the sleeve 44 and brackets 46 may be constructed from any desired type of material, plastic or other type of flexible material may be utilized, although metal may also be used.

The adjustable attachment member 20 is mounted to the shaft 16 utilizing an adjustment element 52. In preferred form, the adjustment element 52 is in the form of a tubular member 54 having a longitudinal slot 56 formed therein. Preferably, the element 52 is made from a flexible material such as plastic, and the slot 56 allows the outer diameter of the element 52 to be adjusted as it is snugly fit within the sleeve 44. The outer diameter of the element 52 is sized and shaped in order to fit within the sleeve 44 so as to be interposed between the sleeve 44 and the shaft 16 in a manner that permits the sleeve 44 with its associated element 52 to be moved along the length of the shaft 16. In preferred form, the adjustment element 52 is in the form of a split bushing to secure sleeve 44 about the shaft 16.

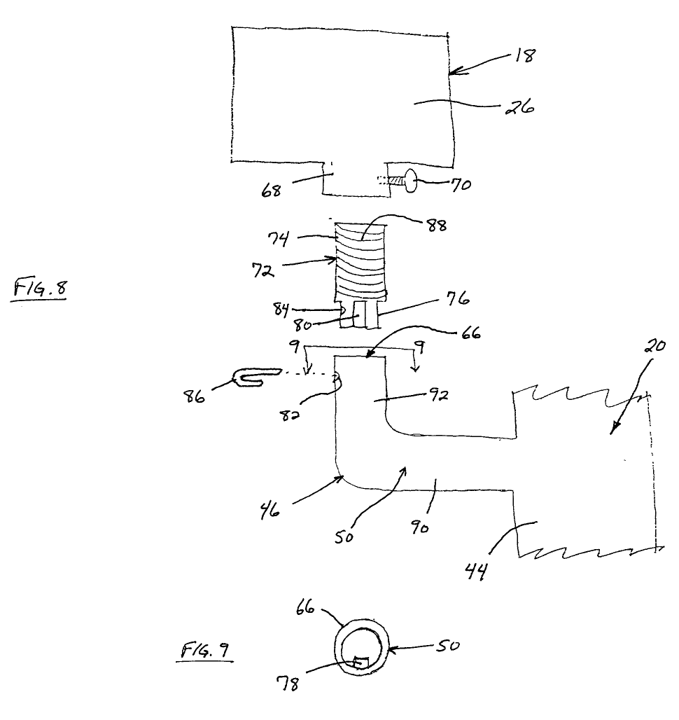

Referring particularly to FIG. 7, the inner and outer diameters of the adjustment element 52 and the sleeve 44 are sized so that the weight from the bracket 46, either alone or particularly when it supports a music performance equipment component 18, leverages the member 20 against the shaft 16 by creating a radially inwardly force at the lowermost corner 58 of the member 20. In other words, the weight tilts the member 20 relative to the shaft 16. This radially inwardly force presses the adjustment element 52 within the sleeve 44 at the juncture 58 against the outer surface of the shaft 16. Moreover, the same weight also creates a radially inwardly force at the diagonally opposite upper corner 60, which in turn presses the diagonally opposite upper corner of the member 20 at the juncture 60 against the shaft 16. The radial inward forces at the junctures 58,60 will hold the adjustable attachment member 20 at any desired position along the length of the shaft 16.

When it is desired to move or adjust this position, an individual performer can simply impose an opposite radial force at the junctures 62,64 until both the adjustment element 52 and the sleeve 44 are substantially coaxially aligned with the shaft 16. At this particular point, the member 20 may then be moved by a sliding motion along the length of the shaft 16 until a new location or position is reached. At this point, the individual performer moving the member 20 can release the member 20, and the weight imposed by the bracket 46 tilts the member 20 again so as to create radially inward forces at junctures 58,60 to maintain the member 20 at its new location or position. The greater the weight imposed on the bracket 46, the more securely the attachment member 20 is maintained at any particular position along the shaft 16. In any event, however, the weight of the bracket 46 alone is sufficient to maintain the adjustment member 20 at any position along the shaft 16.

Referring now to FIGS. 1, 2, 8 and 9, an adjustable attachment member 20 is illustrated having a sleeve 44 and an integrally molded bracket 50 associated therewith. Music performance equipment component 18, such as a monitor 26, is secured to the distal end 66 of the bracket 50. In one form of the invention, the component 18 may be directly secured to the bracket 50. In this form, the component 18 may include a mounting base 68 which is sized and shaped to directly receive the distal end 66 therein. Once the distal end 66 has been inserted within the mounting base 68, a thumbscrew 70 or other suitable securing element is utilized to firmly secure the distal end 66 within the base 68.

In the illustrated embodiment, the base 68 has a diameter greater than that of the distal end 66. In this instance, an adapter element 72 is provided having a first diameter end 74 sized to snugly fit within the base 68, and a second reduced diameter end 76 sized to snugly fit within the distal end 66. In order to assist in firm attachment between the monitor 26 and the bracket 50, the distal end 66 may include a tooth element 78 which is sized and shaped to fit within a slot 80 formed in the adapter end 76. To further ensure a snug and firm attachment between the adapter 72 and the distal end 66, a pair of apertures 82, 84 are provided, respectively, in the distal end 66 and the reduced diameter end 76. A mounting wire or clip 86 is provided for insertion within the apertures 82 and 84 in order to interconnect the distal end 66 with the adapter 72. The adapter 72 may be threadingly engaged within the base 68 utilizing threaded members 88, or it may be securely fastened within the base 68 using the thumb screw 70 as in the previously described embodiment.

The brackets 46 are each preferably formed from two portions. A first portion 90 extends generally radially outwardly from the sleeve 44 of the member 20, while the second portion 92 extends angularly from the end of the first portion 90. In preferred form, the angle between the two portions 90, 92 is about 150° or less as illustrated by the angle “X” of FIG. 1, while the preferred angle is a right angle of about 90° as illustrated in FIGS. 2 and 8. The preferred angle of 90° provides the maximum support for the weight of the component 18 and also provides the maximum radial force against the junctures 58, 60 as discussed above. In this manner, the equipment components 18 are given maximum support while enabling their position along the shaft 16 to be most easily maintained.

As can be seen from the above, the present invention provides a novel music stand device which is portable for easy assembly and disassembly as well as for easy transportation between locations. Moreover, the stand of the invention allows a performer to assemble all of his or her required music performance equipment components on one stand proximate to his or her playing position on a stage. This greatly reduces the clutter and congestion previously associated with stage performances when the performers are providing both vocal as well as instrumental performing. In addition, the stand of the present invention provides a novel adjustable attachment member for the equipment components which enables both easy assembly and disassembly as well as one-handed positional adjustment during a performance. Prior connection devices generally required both hands to effect any vertical positional adjustment, if at all possible, in a music stand during a performance, and this required the performer to cease playing any musical instrument to free up both hands, a requirement which is now obviated by the present invention.

The foregoing description and the illustrative embodiments of the present invention have been described in detail in varying modifications and alternate embodiments. It should be understood, however, that the foregoing description of the present invention is exemplary only, and that the scope of the present invention is to be limited to the claims as interpreted in view of the prior art. Moreover, the invention illustratively disclosed herein suitably may be practiced in the absence of any element which is not specifically disclosed herein.

I claim:

1. A portable music stand for securely holding a plurality of music performance equipment components, said stand comprising:
a base for supporting said stand on a surface;
an elongated shaft releasably engaged with and extending vertically upwardly from said base;
a plurality of adjustable attachment members disposed for selective mounting along said shaft, each said attachment member being adapted to support at least one music performance equipment component; and
a plurality of adjustment elements each interconnecting one said attachment member with said shaft and adapted to permit one-handed vertical repositioning of the associated attachment member along the length of said shaft.

2. The music stand as claimed in claim 1, wherein said music performance equipment components are selected from the group consisting of microphones, microphone clamps, microphone booms, monitor speakers and sheet music rack holders.

3. The music stand as claimed in claim 2, wherein said stand comprises at least two of said adjustable attachment members, one for supporting a monitor speaker and one for supporting a sheet music rack holder.

4. The music stand as claimed in claim 3, wherein said stand comprises a third said adjustable attachment member for supporting a microphone clamp and microphone secured thereto.

5. The music stand as claimed in claim 1, wherein said stand further comprises a microphone boom attachment clamp disposed at the uppermost distal end of said shaft.

6. The music stand as claimed in claim 1, wherein said adjustable attachment member comprises an outer sleeve sized to readily slide over said elongated shaft and a bracket arm extending radially outwardly from said sleeve adapted to mount and carry at least one said music performance equipment component.

7. The music stand as claimed in claim 6, wherein said bracket arm is detachably secured to said sleeve.

8. The music stand as claimed in claim 6, wherein said bracket arm is an integral portion of said sleeve.

9. The music stand as claimed in claim 6, wherein said bracket arm includes at least two portions aligned no more than about 150° relative to each other.

10. The music stand as claimed in claim 9, wherein said bracket arm portions include a first portion aligned approximately perpendicular to said sleeve, and a second portion aligned at approximately 90° relative to said first bracket arm portion.

11. The music stand as claimed in claim 1, wherein each said adjustable attachment member comprises an outer sleeve sized to readily slide over said elongated shaft, and each said adjustment element comprises an inner tubular element disposed radially inwardly of said outer sleeve for positioning between said outer sleeve and the shaft, said inner tubular element having an elongated slot defined in its length to permit adjustment of the diameter thereof.

12. The music stand as claimed in claim 11, wherein said tubular element comprises a flexible split bushing.

13. An attachment element for adjustably securing music performance equipment to a substantially vertically aligned, tubular shaft member for support thereon and adapted to permit one-handed position adjustment thereof along the length of said shaft, said attachment element comprising:
an outer tubular sleeve sized to readily slide over the tubular shaft member;
a bracket arm extending radially outwardly from said sleeve and adapted to mount and carry at least one component of music performance equipment; and
an inner tubular element disposed radially inwardly of said outer sleeve for positioning between said outer sleeve and the shaft member, said inner tubular element having an elongated slot defined in its length to permit adjustment of the diameter thereof.

14. The attachment element as claimed in claim 13, wherein said inner tubular element comprises a flexible split bushing.

15. The attachment element as claimed in claim 14, wherein said bushing is sized to snugly fit over said shaft member.

16. The attachment element as claimed in claim 13, wherein said inner tubular element is adapted to leverage against said shaft member to maintain the vertical position of said attachment element relative to said shaft member resulting from weight imposed thereon by said bracket arm and any music performance equipment supported thereby.

17. The attachment element as claimed in claim 13, wherein said bracket arm is detachably secured to said sleeve member.

18. The attachment element as claimed in claim 13 wherein said bracket arm is an integral portion of said sleeve member.

19. The attachment element as claimed in claim 13, wherein said bracket arm is angular in shape forming substantially two portions aligned at an angle relative to each other and includes means at its distal end to mount music performance equipment.

20. The attachment element as claimed in claim 19, wherein the angle between said two bracket arm portions is approximately 90°.

21. The attachment element as claimed in claim 19, wherein the angle between said two bracket arm portions is more than 90°.

22. The attachment element as claimed in claim 19, wherein said music performance equipment mounting means includes an adapter member having two ends of different diameters, one end being mountable to said bracket arm distal end and a second end mountable to a component of music performance equipment.

23. A portable music stand for securely holding a plurality of music performance equipment components, said stand comprising:
a base for supporting said stand on a substantially flat surface;
an elongated shaft releasably engaged with and extending vertically upwardly from said base;
a plurality of adjustable attachment members disposed for selective mounting along said shaft, each said attachment member including an outer tubular housing sized and shaped to readily slide over said shaft, and an inner tubular element disposed radially inwardly of said outer housing for positioning between said outer housing and said shaft and including a longitudinal slot therealong to permit one-handed vertical repositioning of the associated attachment member along the length of said shaft; and
a bracket arm extending radially outwardly from each said attachment member outer housing and being adapted to support at least one music performance equipment component at the distal end thereof.

24. The portable music stand as claimed in claim 23, wherein said music performance equipment components are selected from the group consisting of microphones, microphone clamps, microphone booms, monitor speakers and sheet music rack holders.

25. The portable music stand as claimed in claim 24, wherein said stand comprises at least two of said adjustable attachment members, one for supporting a monitor speaker and one for supporting a sheet music rack holder.

26. The portable music stand as claimed in claim 25, wherein said stand comprises a third said adjustable attachment member for supporting a microphone clamp and microphone secured thereto.

27. The portable music stand as claimed in claim 23, wherein said bracket arm is detachably secured to said outer tubular housing.

28. The portable music stand as claimed in claim 23, wherein said bracket arm is an integral portion of said outer tubular housing.

29. The portable music stand as claimed in claim 23, wherein said bracket arm is angular in shape forming substantially two portions aligned at an angle relative to each other and includes means at its distal end to mount music performance equipment components.
